(19) United States
(12) Patent Application Publication
(10) Pub. No.: US 2016/0222996 A1
(43) Pub. Date: Aug. 4, 2016

(54) System and Method for Predicting Failure of a Hydrostatic System Component

(71) Applicant: Caterpillar Inc., Peoria, IL (US)

(72) Inventor: Jeremy Couch, Peoria Heights, IL (US)

(73) Assignee: Caterpillar Inc., Peoria, IL (US)

(21) Appl. No.: 14/610,208

(22) Filed: Jan. 30, 2015

(51) Int. Cl. F15B 19/00

(52) U.S. Cl. CPC F15B 19/005

(57) ABSTRACT

System and methods for analyzing wear of a component in a hydrostatic system and/or predicting failure of the component are disclosed. One method includes determining a first displacement ratio reflecting a relationship between a first displacement of a pump in a hydrostatic system and a first displacement of a motor fluidly coupled to the pump, determining a first speed ratio reflecting a relationship between a first speed of the pump and a first speed of the motor, and determining a first system efficiency of the hydrostatic system based on the first displacement ratio and the first speed ratio, wherein the first system efficiency is indicative of wear of a component of the hydrostatic system.

### TECHNICAL FIELD

This patent disclosure relates generally to hydrostatic systems, and more particularly to a system and method for predicting failure of a hydrostatic system component.

### BACKGROUND

A hydrostatic system typically includes a pump and a motor, among other components. When a pump or motor fails, debris resulting from the failure may be sent out to other parts of the hydrostatic system and cause damage to those other parts.

U.S. Pat. No. 7,082,758 discloses a system and method for monitoring the health of a hydraulic machine. The disclosed system and method operate to monitor the health of a hydraulic machine by analyzing a representative oil filter differential pressure, which is determined using a discharge pressure, an oil temperature, and a drain filter differential pressure. However, U.S. Pat. No. 7,082,758 does not disclose leveraging system efficiencies such as a comparison between speed and displacement signals to generate a prognosis of the health of the system. Accordingly, there is a continued need to predict the failure of a pump or motor so that the pump or motor may be pro-actively repaired before the failure and subsequent damage to other parts of the hydrostatic system.

### SUMMARY

This patent disclosure relates to system and methods for predicting failure of a hydrostatic system component. In an aspect, a method may include determining a first displacement ratio reflecting a relationship between a first displacement of a pump in a hydrostatic system and a first displacement of a motor fluidly coupled to the pump, determining a first speed ratio reflecting a relationship between a first speed of the pump and a first speed of the motor, and determining a first system efficiency of the hydrostatic system based on the first displacement ratio and the first speed ratio, where the first system efficiency is indicative of wear of a component of the hydrostatic system.

In an aspect, a method may include determining a first displacement ratio reflecting a relationship between a first displacement of a pump in a hydrostatic system and a first displacement of a motor fluidly coupled to the pump, determining a first speed ratio reflecting a relationship between a first speed of the pump and a first speed of the motor, and determining a first operational characteristic of the hydrostatic system based at least on the first displacement ratio and the first speed ratio, where the first operational characteristic is indicative of wear of a component of the hydrostatic system.

In an aspect, a system may include a processor and a memory bearing instructions that, upon execution by the processor, cause the system at least to: determine a first displacement ratio reflecting a relationship between a first displacement of a pump in a hydrostatic system and a first displacement of a motor fluidly coupled to the pump, determine a first speed ratio reflecting a relationship between a first speed of the pump and a first speed of the motor, and determine a first system efficiency of the hydrostatic system based on the first displacement ratio and the first speed ratio, where the first system efficiency is indicative of wear of a component of the hydrostatic system.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed.

FIG. 1 is a side view of a machine with a hydrostatic drive system in accordance with aspects of the disclosure.

FIG. 2 illustrates a schematic view of an exemplary hydrostatic drive system in accordance with aspects of the disclosure.

FIG. 3 illustrates a block diagram of an exemplary data flow for predicting a failure of a hydrostatic system component in accordance with aspects of the disclosure.

FIG. 4 illustrates a graph showing a series of moving averages of system efficiency over time in accordance with aspects of the disclosure.

FIG. 5 illustrates a graph showing a series of moving averages of system efficiency over time in accordance with aspects of the disclosure.

FIG. 6 is a flow chart of an exemplary method in accordance with aspects of the disclosure.

FIG. 7 is a block diagram of a computer system configured to implement the method of FIG. 6.

### DETAILED DESCRIPTION

In an aspect, systems and methods are disclosed that may utilize pump and motor measurements of a hydrostatic system to determine hydrostatic system efficiency. As an example, with knowledge of the displacement and speed of both the pump and motor, system efficiency may monitored over time, along with multiple versions of its moving average, to determine when a system component is going to fail. Such systems and methods may reduce unscheduled downtime by reducing the likelihood of a pump or motor catastrophic failure and derivative hydraulic system component failures, for example.

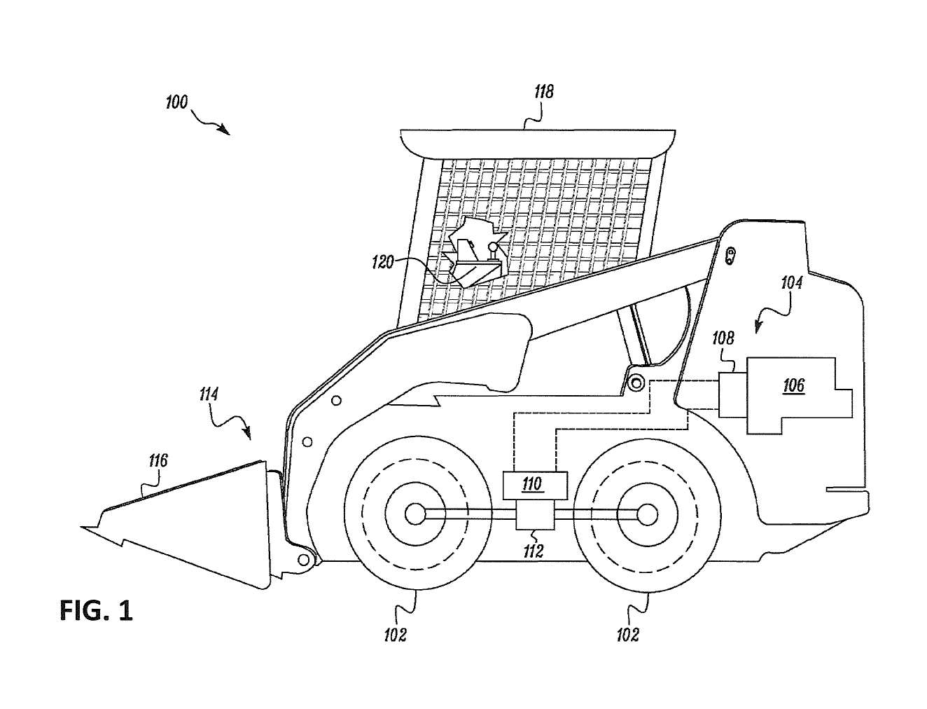

FIG. 1 illustrates an exemplary hydrostatic drive machine 100 in accordance with aspects of the disclosure. The machine 100 includes one or more ground engaging members 102 such as wheels, and a hydrostatic drive system 104 for powering the ground engaging members 102 to propel the machine 100. The hydrostatic drive system 104 may include a power source 106, a pump 108 configured to be driven by an output shaft of the power source 106, a hydraulic motor 110, and a transmission 112. Although, the machine 100 is embodied as a skid steer loader having an implement system 114 including a bucket 116, the machine 100 may be of any wide variety of other hydrostatic drive machines well known in the art.

The power source 106 may include an internal combustion engine, such as, for example, a diesel engine, a gasoline engine, a gaseous fuel-powered engine, or any other type of engine known in the art. Alternatively, the power source 106 may include a non-combustion source of power such as a fuel cell, a power storage device, or another source known in the art. The power source 106 may produce a mechanical or electrical power output that may be converted to hydraulic power for operating the implement system 114, propelling the machine 100, and the like operated by the hydrostatic drive system 104.

Further, the machine 100 includes an operator station 118, which may include one or more operator interface devices 120 to control machine speed and travel directions of the machine 100. The operator interface devices 120 may include a single or multi-axis joysticks or levers or pedals or switches, dial, a touch based interface, a voice based interface or the like, located proximal an operator seat. In an aspect of the present disclosure, the operator interface devices 120 may also include a multi-speed, momentary switch.

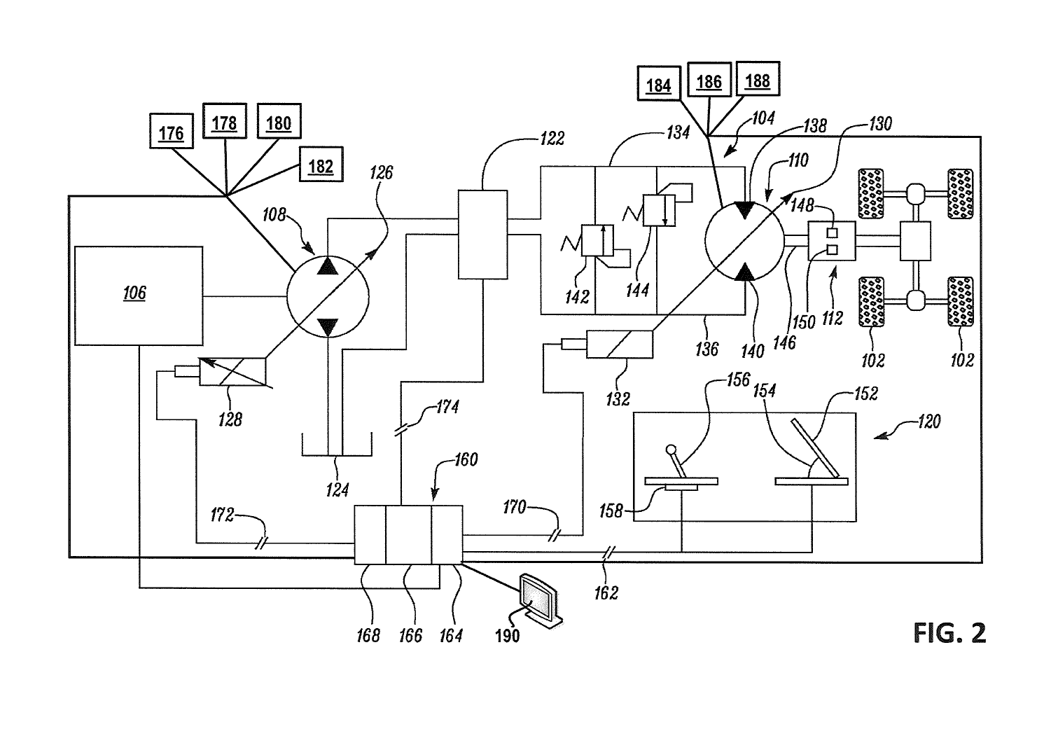

FIG. 2 illustrates a schematic of the hydrostatic drive system 104, according to various aspects of the present disclosure. In an exemplary arrangement, the hydrostatic drive system 104 may include, among other things, a control valve 122 to selectively control a flow of pressurized fluid from the pump 108 to the hydraulic motor 110 and from the hydraulic motor 110 to a low-pressure tank 124 to propel the machine 100. The pump 108 may be a variable displacement pump of any well-known construction and type, such as, a gear pump, a rotary vane pump, a screw pump, an axial piston pump or a radial piston pump. The pump 108 may include a pump swash plate 126 connected to a first swash plate control valve 128. The first swash plate control valve 128 may be a variable solenoid valve and configured to selectively control a pump displacement of the pump 108 by adjusting an angle of the pump swash plate 126. The pump 108 may be communicatively connected to one or more sensors relating to the operation of the pump 108, including a pump discharge pressure sensor 176, a pump fluid temperature sensor 178, a pump speed sensor 180, and a pump displacement sensor 182. The pump discharge pressure sensor 176 may provide a signal indicating the pressure at which a fluid is discharged from the pump 108. The pump fluid temperature sensor may provide a signal indicating the temperature of the hydraulic fluid within the pump 108. The pump speed sensor 180 may provide a signal indicating the speed at which the pump 108 is operating, such as the revolutions per minute of a gear in a gear-type pump or the reciprocations per minute of a piston-type pump. The pump displacement sensor 182 may provide a signal indicating the displacement volume of the pump 108.

The hydraulic motor 110 may be a variable displacement hydraulic motor of any well-known construction and type, such as, an axial plunger motor, a gerotor motor, a gear and vane motor or a radial piston motor. The hydraulic motor 110 may include a motor swash plate 130 connected to a second swash plate control valve 132. The second swash plate control valve 132 may be a solenoid valve and may be configured to selectively control a motor displacement of the hydraulic motor 110 by adjusting an angle of the motor swash plate 130. In an aspect, the hydraulic motor 110 may be a two-speed motor which is adjustable between a maximum displacement orientation and a minimum displacement orientation. The hydraulic motor 110 may be communicatively connected to one or more sensors relating to the operation of the hydraulic motor 110, including a motor fluid temperature sensor 184, a motor speed sensor 186, and a motor displacement sensor 188. The motor fluid temperature sensor 184 may provide a signal indicating the temperature of the hydraulic fluid within the motor 110. The motor speed sensor 186 may provide a signal indicating the speed at which the motor 110 is operating, such as the revolutions per minute of a gear or vane within the motor 110 or the reciprocations per minute of a plunger within the motor 110. The motor displacement sensor 188 may provide a signal indicating the displacement volume of the motor 110.

In an aspect, the hydraulic motor 110 may be a bi-directional motor and include a first motor conduit 134 and a second motor conduit 136. In the illustrated aspect, the first motor conduit 134 is provided between the control valve 122 and a first port 138 of the hydraulic motor 110. Further, the second motor conduit 136 is provided between the control valve 122 and a second port 140 of the hydraulic motor 110. In an aspect of the present disclosure, the control valve 122 may be a directional control valve to start, stop or change the flow of the pressurized fluid and control the rotation of the hydraulic motor 110. In an aspect, the control valve 122 may be a solenoid operated, variable position, four-way, three-position valve movable between a first working position, wherein the first port 138 is in fluid communication with the pump 108 and the second port 140 is in fluid communication with the tank 124, a second working position, wherein the first port 138 is in fluid communication with the tank 124 and the second port 140 is in fluid communication with the pump 108, and a neutral position, wherein the flow from the pump 108 to the hydraulic motor 110 is blocked. In another aspect, the control valve 122 may include an independent metering valve (IMV) system that includes plurality of independently-operated valves.

In an aspect, a pair of cross-line pressure relief valves 142, 144 may be provided to interconnect the first and the second motor conduits 134, 136. The pressure relief valves 142, 144 may allow an excessive pressure above a predetermined value in one of the first and second motor conduits 134, 136 to relieve to the other of the first and the second motor conduits 134, 136.

The hydraulic motor 110 in turn is coupled with the transmission 112 to transmit rotational power produced at an output shaft 146 of the hydraulic motor 110 to the ground engaging members 102 via respective differentials. The transmission 112 may embody a multi-speed, bidirectional, mechanical transmission having a neutral gear ratio, multiple forward gear ratios, and multiple reverse gear ratios. In an aspect, the forward gear ratios may include a low speed gear 148 and a high speed gear 150.

Moreover, the operator interface devices 120, which may be located in the operator station 118, may include a throttle pedal 152 having a throttle position sensor (TPS) 154, and a gear selector lever 156 having a lever position sensor 158. The TPS 154 and the lever position sensor 158 are configured to regulate machine speed and gear ratio settings of the transmission 112 based on an input received from an operator. As shown in FIG. 2, a controller 160 is provided to regulate the operation of the hydrostatic drive system 104. The controller 160 may be an electronic controller that may include a processor operably associated with other electronic components such as data storage devices and various communication channels. In an aspect, the controller 160 may include a data structure to selectively engage the transmission 112 in the low speed gear 148 or the high speed gear 150 in response to an input signal 162 received from the operator interface devices 120, such as the TPS 154, and the lever position sensor 158.

The controller 160 may be operably connected to the first swash plate control valve 128, the second swash plate control valve 132, and the transmission 112 to regulate the operation of the hydrostatic drive system 104 during shifting from the low speed gear 148 to the high speed gear 150, and vice versa. The controller 160 may include a signal receiving module 164, a data storage module 166, and a processing module 168. The signal receiving module 164 may be configured to receive signals using various communication channels. The data storage module 166 may include for example, but not limited to, a Random Access Memory (RAM), a Read Only Memory (ROM), flash memory, a data structure, and the like. The controller 160 may be communicatively connected to a user interface 190. The user interface 190 may include a digital display, a gauge, a light, an audio alarm, or any other device for communication with a user. The data storage module 166 may store a control algorithm or a computer executable code to output a motor displacement command signal 170 and a pump displacement command signal 172 to adjust the displacement and/or rate of change in displacement of the motor swash plate 130 of the hydraulic motor 110 and the pump swash plate 126 of the pump 108, respectively, based on the input signal 162 received from the operator interface devices 120. Moreover, the data storage module 166 may also store a computer executable code to output a control signal 174 to control the flow of the pressurized fluid from the pump 108 to the hydraulic motor 110 via the control valve 122. The data storage module 166 may be operable on the processing module 168 to output the motor displacement command signal 170, the pump displacement command signal 172, and the control signal 174. The data storage module 166 may store a control algorithm or a computer executable code to output a communication to the user interface 190 reflecting an operational characteristic, such as system efficiency, of the hydrostatic drive system 104 or component thereof.

The controller 160 may be communicatively connected to the pump discharge pressure sensor 176, the pump fluid temperature sensor 178, the pump speed sensor 180, the pump displacement sensor 182, the motor fluid temperature sensor 184, the motor speed sensor 186, and the motor displacement sensor 188. The controller 160 may be configured to receive a pump sensor signal indicative of the operating status of the pump 108 and a motor sensor signal indicative of the operating status of the hydraulic motor 110.

In an aspect, the controller 160 may include physical and/or logical elements for determining the desired machine speed and the current machine speed based at least in part based on the TPS 154, and the lever position sensor 158. During an acceleration mode, the signal receiving module 164 is configured to receive the input signal 162 indicative of the desired machine speed greater than the current machine speed. In an aspect, during the acceleration mode the input signal 162 may be indicative of shift from the low speed gear 148 to the high speed gear 150. According to an exemplary aspect of the present disclosure, the controller 160 is further configured to output the motor displacement command signal 170 to upshift or decrease the displacement of the motor swash plate 130 of the hydraulic motor 110 to the minimum displacement orientation corresponding to the desired machine speed. The controller 160 may further be configured to output the pump displacement command signal 172 to decrease the displacement of the pump swash plate 126 of the pump 108 to maintain the current machine speed while decreasing the displacement of the motor swash plate 130 of the hydraulic motor 110. Further, once the displacement of the motor swash plate 130 of the hydraulic motor 110 is decreased, the controller 160 is further configured to output the pump displacement command signal 172 to increase the displacement of the pump swash plate 126 of the pump 108 with a constant acceleration to achieve the desired machine speed.

Moreover, during a deceleration mode, the signal receiving module 164 is configured to receive the input signal 162 indicative of the desired machine speed less than the current machine speed. In an aspect, during the deceleration mode the input signal 162 may be indicative of shift from the high speed gear 150 to the low speed gear 148. According to an exemplary aspect, the controller 160 is configured to output the pump displacement command signal 172 to decrease the displacement of the pump swash plate 126 of the pump 108 to achieve the desired machine speed. Once, the displacement of the pump swash plate 126 of the pump 108 is decreased and the machine 100 is at the desired machine speed, the controller 160 is further configured to output the motor displacement command signal 170 to downshift or increase the displacement of the motor swash plate 130 of the hydraulic motor 110 to the maximum displacement orientation corresponding to the desired machine speed. The controller 160 is further configured to output the pump displacement command signal 172 to increase the displacement of the pump swash plate 126 of the pump 108 with a constant deceleration to maintain the desired machine speed while increasing the displacement of the motor swash plate 130 of the hydraulic motor 110.

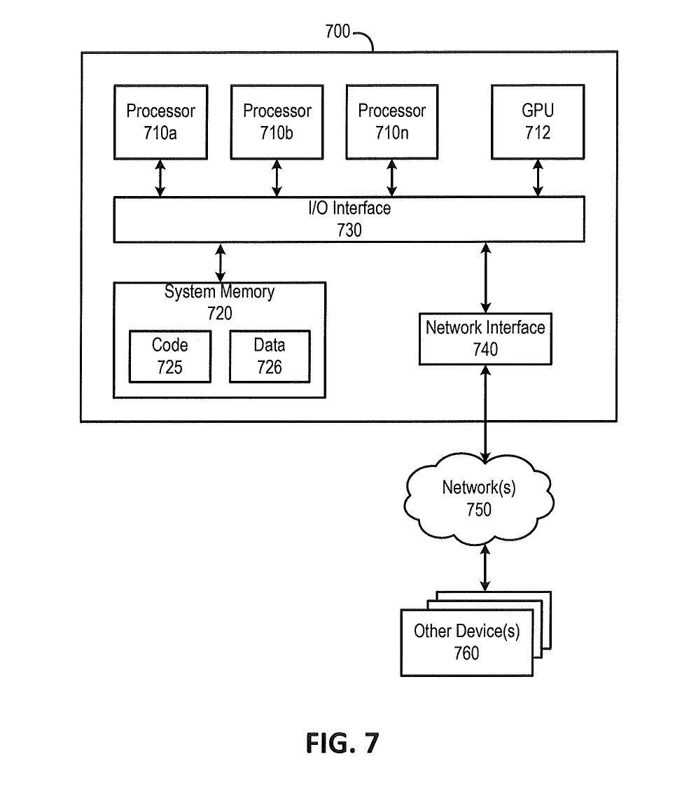

In an aspect, the controller 160 or processing element (e.g., processors 710 (FIG. 7)) may be configured to receive information relating to the displacement of the pump 108 and the motor 110 and a speed of the pump 108 and the motor 110. As an example, the displacement of the pump 108 and the motor 110 may represent a command ratio for a desired output of the pump 108 and the motor 110, whereas the speed of the pump 108 and the motor 110 may represent and actual performance output ratio of the pump 108 and the motor 110. A comparison of the displacement ratio of the pump 108 and the motor 110 and the speed ratio of the pump 108 and the motor 110 may indicate an overall efficiency of the hydrostatic drive system 104 (e.g., command vs. actual performance output). As a further example, one or more of the displacement information, speed information, and system efficiency may be used to estimate wear of a component of the hydrostatic drive system 104.

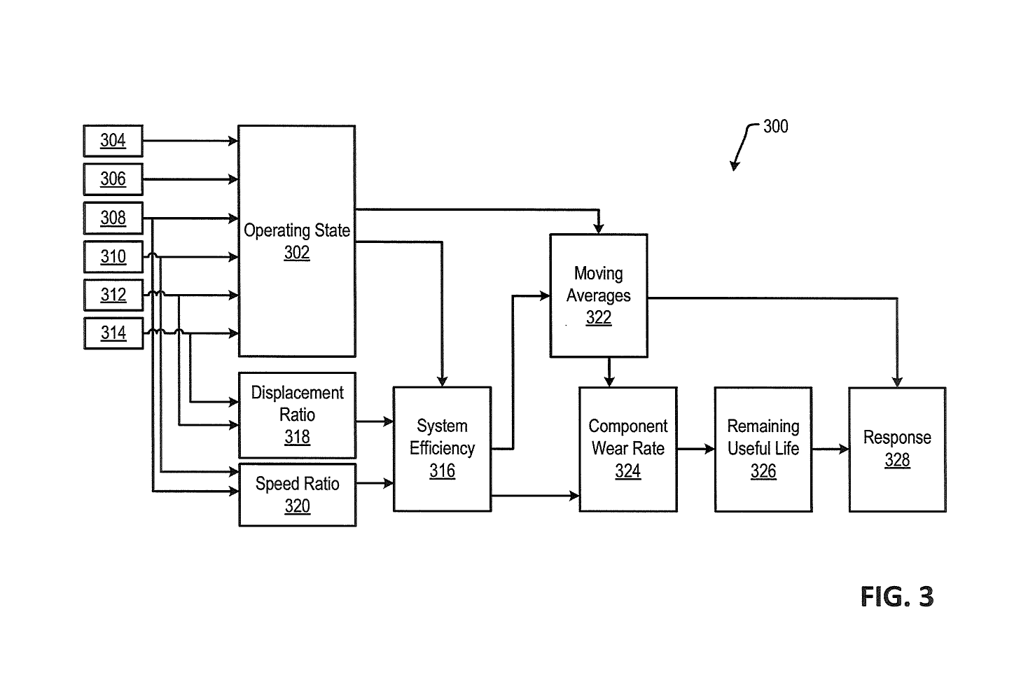

FIG. 3 depicts a block diagram of an exemplary data flow 300 of various operations relating to a method to predict a failure of a hydrostatic system component. In an aspect, at module 302, an operating state of a hydrostatic drive system 104 may be determined. As an example, the operating state may be determined by one or more controllers or processors, for example controller 160 or processors 710. The operating state of the hydrostatic drive system 104 may be determined based on one or more inputs. An input may be indicative of pump discharge pressure 304, hydraulic fluid temperature 306, pump speed 308, motor speed 310, pump displacement 312, and motor displacement 314. As a further example, the determination of an operating state may be performed by a processing module 168 of a controller 160. The inputs may be received by a signal receiving module 164 and from one or more sensors in the hydrostatic drive system 104, such as a pump discharge pressure sensor 176, a pump fluid temperature sensor 178, etc. Further, an input may be indicative of a user input, such as from a TPS 154 or a lever position sensor 158.

In module 316, a system efficiency may be calculated. The calculation of the system efficiency may be performed by the processing module 168 and may be based on the operating state determined by module 302, a displacement ratio 318, a speed ratio 320, or a combination thereof The system efficiency may reflect an overall system efficiency of the hydrostatic drive system 104, e.g., a relationship of the energy put into the system to the energy output from the system. As an example, the system efficiency may be calculated according to a relationship between the actual and the theoretical displacement and/or speed measurements. As a another example, a displacement ratio may be calculated by forming a ratio of a pump displacement to the motor displacement or vice versa and a speed ratio may be calculated by forming a ratio of the pump speed to the motor speed or vice versa.

The displacement ratio 318 may be determined based on at least the pump displacement 312 and the motor displacement 314. As an example, the pump displacement 312 and/or the motor displacement 314 may be received from a signal originating from the pump displacement sensor 182 and the motor displacement sensor 188, respectively. As another example, the pump displacement 312 and/or the motor displacement 314 may be determined based on a stored value or a user input (e.g., from a TPS 154 or a lever position sensor 158) corresponding to known pump and motor displacements. In an aspect, the displacement ratio 318 may be calculated by forming a ratio of the pump displacement 312 to the motor displacement 314 or vice versa. As an example, the displacement ratio 318 may reflect a command gear ratio (GR_{cmd}) representing a desired output of the hydrostatic drive system 104 and may be calculated based on the following formula:

$${GR}_{cmd} = \frac{{D}_{pump}}{{D}_{motor}} ,$$

where GR_{cmd} represents the displacement ratio 318, Dₚᵤₘₚ represents the pump displacement 312, and Dₘₒₜₒᵣ represents the motor displacement 314.

The speed ratio 320 may be determined based on at least the pump speed 308 and the motor speed 310. As an example, the pump speed 308 and/or the motor speed 310 may be received from a signal originating from the pump speed sensor 180 and the motor speed sensor 186, respectively. In an aspect, the speed ratio 320 may be calculated by forming a ratio of the pump speed 308 to the motor speed 310 or vice versa. As an example, the speed ratio 320 may reflect an actual gear ratio (GR_{act}) representing an actual output of the hydrostatic drive system 104 and may be calculated based on the following formula:

$${GR}_{act} = \frac{{N}_{motor}}{{N}_{pump}} ,$$

where GR_{act} represents the speed ratio 320, Nₚᵤₘₚ represents the pump speed 308, and Nₘₒₜₒᵣ represents the motor speed 310.

In an aspect, using the displacement ratio 318 and the speed ratio 320 as inputs, the system efficiency may be calculated. As an example, the system efficiency may be calculated based on the following formula:

$${η}_{sys} = \frac{{GR}_{act}}{ {GR}_{cmd}} ,$$

where η_{sys} represents the system efficiency, GR_{act} represents the speed ratio 320, and GR_{cmd} represents the displacement ratio 318. As another example, the system efficiency represented by η_{sys} may be compared against a table of stored system efficiencies. For example, such stored values may be model values calculated as if the system were operating at a theoretical maximum efficiency. To illustrate, the table may indicate that at the actual displacement ratio 318, the actual speed ratio 320 should be a certain value if the system were operating at maximum efficiency. Instead, the actual speed ratio 320 may be measured at a value half of the maximum efficiency value. Accordingly, on a scale of 0 to 1, the calculated system efficiency may be 0.5. Other mechanisms for calculating the system efficiency may be used.

The operating state of module 302 may be used to group the system efficiency calculations. For example, an operating state indicating a low temperature of the hydraulic fluid, and thus a low viscosity of the fluid, may correspond to a lower system efficiency. Conversely, a high hydraulic fluid temperature may correspond to a higher system efficiency. As a result, these system efficiencies may not be comparable for the purpose of determining the moving averages 322, the component wear rate 324, remaining useful life 326, and/or response 328. Instead, only system efficiencies calculated under the same grouped operating state may be compared for the purpose of determining the moving averages 322, the component wear rate 324, remaining useful life 326 or response 328. Various operating states may be defined and may be used to group system efficiency calculations. As an illustrative example, system efficiencies that are calculated under low pressure conditions may be grouped together in a low pressure group for comparison and/or generation of moving averages for the low pressure group. As another illustrative example, system efficiencies that are calculated under high temperature conditions may be grouped together in a high temperature group for comparison and/or generation of moving averages for the high temperature group.

In module 322, one or more system efficiencies from module 316, each corresponding to a time increment, may be used to determine a series of exponentially weighted moving averages, including but not limited to a short-term moving average and a long-term moving average. The calculation of the long-term and short-term averages may be executed in an iterative process such that as time passes, the most recent system efficiencies are included in the calculations. As an example, the long-term and short-term averages may be weighted based on the following formula:

Yₛₕₒᵣₜ_{ₙ}=(1−λₛₕₒᵣₜ)Yₛₕₒᵣₜ_{ₙ₋₁}+λₛₕₒᵣₜη_{sys}

Y_{long}_{ₙ}=(1−λ_{long})Y_{long}_{ₙ₋₁}+λ_{long}η_{sys}

, where Yₛₕₒᵣₜ₍ₙ₎ represents the exponentially weighted short-term moving average at time n, Y_{long(n)} represents the exponentially weighted long-term moving average at time n, λₛₕₒᵣₜ represents the short-term weighting factor, λ_{long} represents the long-term weighting factor, and η_{sys} represents the current system efficiency. In this example, the short-term moving average is an average placing more weight (greater value of λₛₕₒᵣₜ compared to λ_{long}) on the current system efficiency, η_{sys}, than on the previous value of the short-term moving average, Yₛₕₒᵣₜ₍ₙ₋₁₎. On the other hand, the long-term moving average is an average placing more weight (lesser value of λ_{long} compared to λₛₕₒᵣₜ) on the current system efficiency, η_{sys}, than on the previous value of the long-term moving average, Y_{long(n-1)}.

In module 324, a component wear estimate may be determined. The determination of component wear may be based on one or more inputs. As an example, one input may be the system efficiency of module 316 of the hydrostatic drive system 104. As another example, one input may be a series of moving averages for the one or more system efficiencies determined in module 316.

In an aspect, the series of moving averages from module 322 may be analyzed to determine the component wear estimation, based on the formula:

$${γ}_{sys} = \frac{{Y}_{long}}{{Y}_{new}} * 100 ,$$

where γ_{sys} represents wear estimation, Y_{long} represents the exponentially weighted long-term moving average, and Y_{new} represents the efficiency of a new system and/or the maximum system efficiency.

In module 326, a remaining useful life (RUL) of the hydrostatic drive system 104 or component thereof may be determined. The remaining useful life may be determined based, in part, on the component wear estimate determined in module 326. For instance, the component wear estimate may be compared with a pre-specified wear threshold at which the hydrostatic drive 104 system is no longer useful—or may catastrophically fail—to arrive at the remaining useful life. The remaining useful life may be expressed as a time value of useful operation time (e.g., 10 hours of operation time). As an example, the RUL may be determined based on the following formula:

RUL=100−γ_{sys}

, where RUL represents the remaining useful life and γ_{sys} represents wear estimation. Based on at least the remaining useful life, a determination may be made that an alarm or RUL indicator should be communicated. For example, if the remaining useful life falls below a certain pre-set threshold, a determination may be made that an alarm or RUL indicator should be communicated. Further, it may be determined to update a display or indicator showing a repetitively updated remaining useful life.

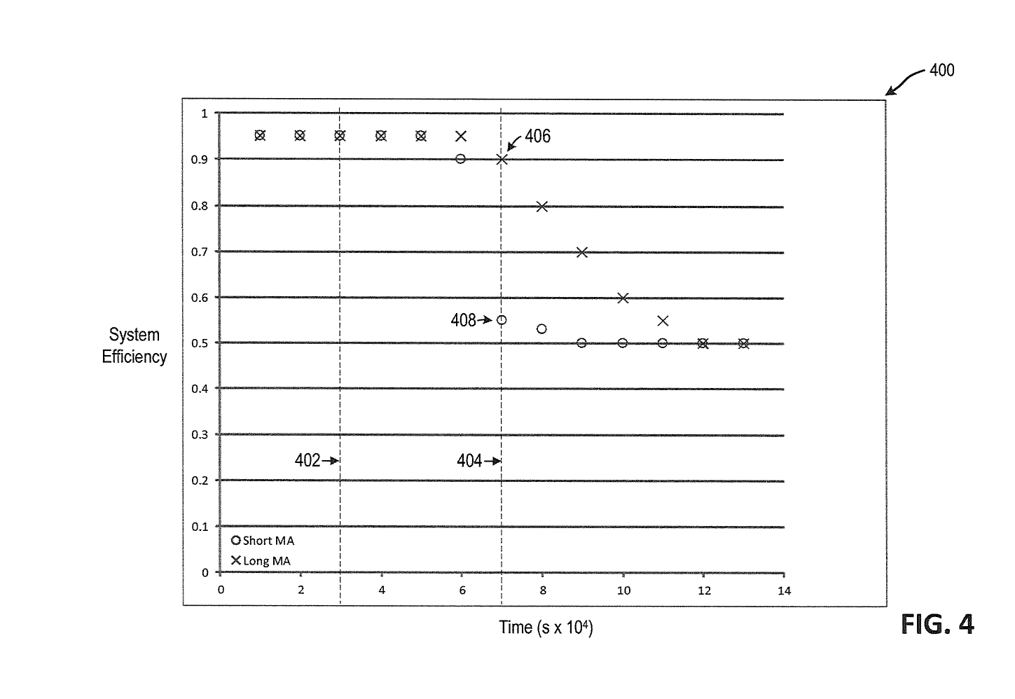

Further alarms, warnings or indicators may be determined appropriate in the response module 328. As an illustration, FIG. 4 depicts a graph 400 of a series of moving averages. The vertical coordinate represents system efficiency and the horizontal coordinate represents increments of time. A series of short-term moving averages from module 322 are shown as circle markings and a series of long-term moving averages from module 322 are shown as X markings. At a first time increment 402, the short-term moving average and the long-term moving average are about equal, indicating little or no change in system efficiency. At a second time increment 404, however, the long-term moving average 406 is about 0.9 system efficiency and the short-term moving average 408 is about 0.55 system efficiency, a differential of about 0.35 in system efficiency. A large differential between the short-term and long-term moving averages may indicate a catastrophic or imminent catastrophic failure of a component of the hydrostatic drive system 104. The indication of the catastrophic of imminent catastrophic failure may be a factor in the generating a response such as an alarm, warning, etc.

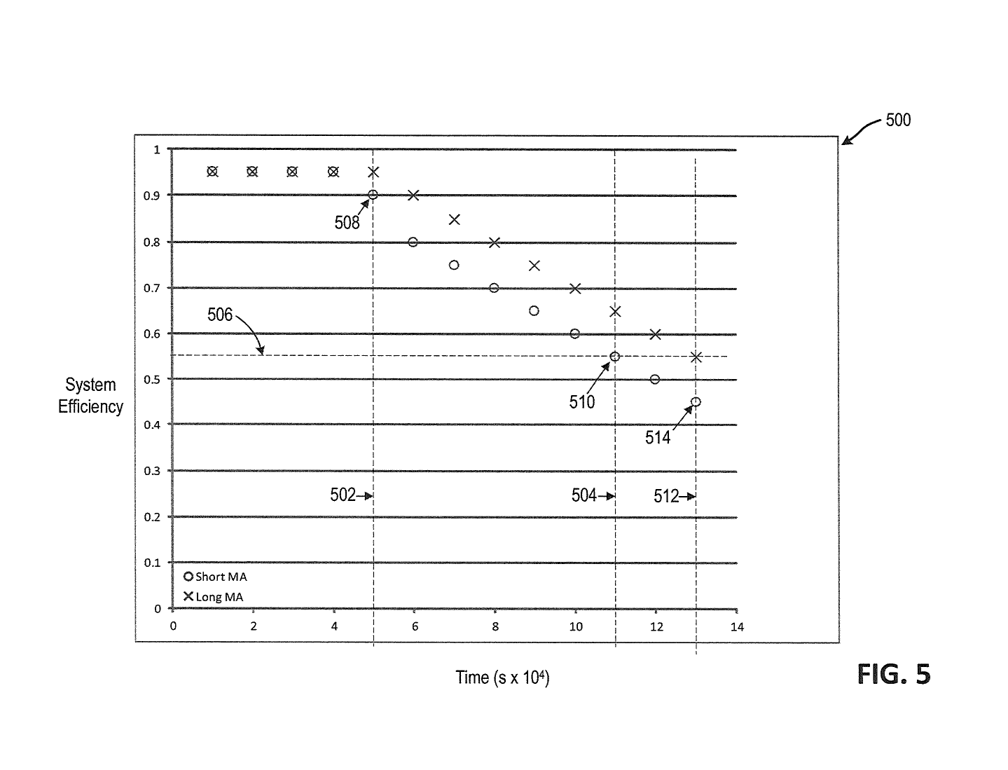

The series of moving averages from module 322 may be used to determine that the system efficiency of the hydrostatic drive system 104 has fallen below or equaled a pre-specified threshold. To illustrate, FIG. 5 depicts a graph 500 similar to the graph 400 of FIG. 4. The graph 500 shows a series of moving averages of system efficiency over increments of time. A pre-specified system efficiency threshold 506 at about 0.55 system efficiency is shown. At the start of the series of time increments, the short-term moving averages and the long-term moving averages are about equal at 0.95 system efficiency. At the first time increment 502, the short-term moving average 508 begins to decline. In the time interval between the first time increment 502 and a second time increment 504, the short-term and long-term moving averages continue to decline at a steady rate. At the second time increment 504, the short-term moving average 510 equals the pre-specified system efficiency threshold 506. It should be appreciated that the pre-specified system efficiency threshold 506 may be analyzed against a long-term moving average instead of or in addition to a short-term moving average. Equaling or falling below the pre-specified system efficiency threshold 506 may indicate a form of gradual component degradation. The indication of the gradual component degradation may be a factor in the generating a response such as an alarm, warning, etc.

It may also be determined that the system efficiency has equaled or fallen below the pre-specified system efficiency threshold 506 for a pre-specified period of time. To illustrate, the pre-specified period of time may be 30000 seconds (3×10⁴ seconds). At a third time increment 512 that is 30000 seconds from the second time increment 504, the short-term moving average 514 is still below the pre-specified system efficiency threshold 506 (and has not risen about it in the interim) and, thus, may indicate a gradual component degradation. As above, the indication of the gradual component degradation may be a factor in the generating a response such as an alarm, warning, etc.

In module 328, a response, such as an alarm or RUL indicator may be communicated to, for instance, the machine 100 operator. The alarm or RUL indicator may be communicated by sending an alarm signal to the user interface 190, which may include a digital display, a gauge, a light, an audio alarm, or any other device for communication with a user. For example, the alarm signal may cause a message or icon to appear on a digital display, an audio alarm to sound, or a warning light to light up. The alarm signal may also cause a display of a real-time remaining useful life, such as a gauge or indicator on a digital display, to update with the latest determined remaining useful life. In an aspect, the response may be triggered based upon a threshold comparison such as exemplified in the following formulas:

Y_{long}<Y_{long}_{ₘᵢₙ}→WARNING

(Y_{long}−Yₛₕₒᵣₜ)>Y_{delta}_{ₘₐₓ}→WARNING

, where Yₛₕₒᵣₜ represents the exponentially weighted short-term moving average, Y_{long} represents the exponentially weighted long-term moving average, Y_{long(min)} represents a minimum threshold for Y_{long} before triggering the response (e.g., a warning), and Y_{delta(max)} represents a maximum threshold for (Y_{long}−Yₛₕₒᵣₜ) before triggering the response (e.g., a warning). Other thresholds and response rules may be configured to provide feedback to a user. Recalling that the series of moving averages may include a short-term and a long-term moving average, a differential between a short-term moving average and a long-term moving average for a given increment of time may be detected. The differential may indicate a drop in system efficiency. The drop in system efficiency may indicate a problem or imminent failure in a component of the hydrostatic drive system 104 and thus be a relevant factor in the determination of raising an alarm. The detection of the differential may occur as an iterative process as new series of moving averages are input to module 324.

It will be appreciated that any of the modules of the data flow 300 described herein may be implemented in the controller 160, including the processing module 168, the data storage module 166, and the signal receiving module 164, and/or via other devices and processors.

### INDUSTRIAL APPLICABILITY

The industrial applicability of the system and methods for predicting failure of a hydrostatic system component herein described will be readily appreciated from the foregoing discussion. Although the machine 100 is illustrated as the skid steer loader in the present disclosure, those skilled in the art may understand that, the machine 100 may be for example, but not limited to, multi-terrain loader, compact track loader, road reclaimer, soil compactor, pneumatic compactor, cold planer, hydraulic excavator or the machine 100 might be any of a wide variety of other hydrostatic drive work machines, many of which are known in the art.

Conventionally, when a pump or a motor in a hydrostatic system fails, it can send debris out to the rest of the hydraulic system and damage other components. If the operator is warned of an imminent pump or motor failure, or given an indication of the remaining life of the system, the machine can be shut down and repaired before additional damage is incurred.

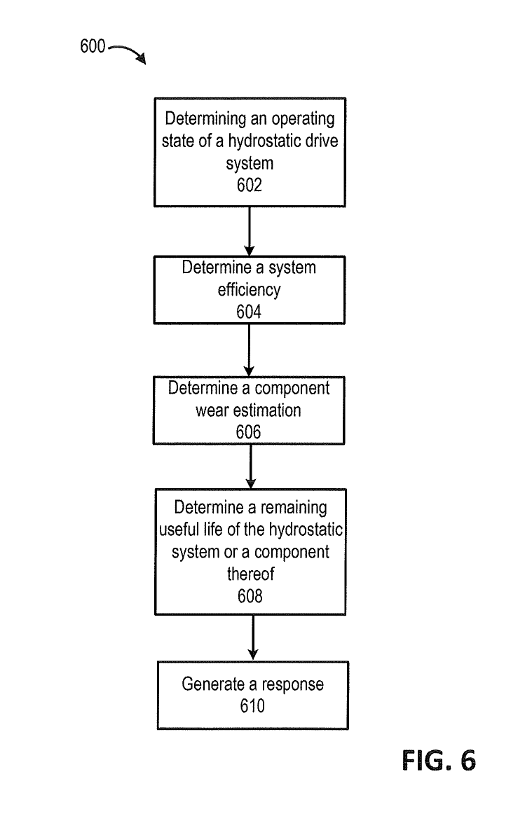

FIG. 6 illustrates a process flow chart for a method 600 for predicting failure of a hydrostatic system component of a machine such as the machine 100 (FIG. 1), according to an aspect of the present disclosure. For illustration, the operations of the method 600 will be discussed in reference to FIGS. 1 and 2. At step 602, an operating state of a hydrostatic drive system 104 may be determined. As an example, the operating state may be determined by one or more controllers or processors, for example controller 160 or processors 710. The operating state of the hydrostatic drive system 104 may be determined based on one or more inputs. An input may be indicative of pump discharge pressure 304, hydraulic fluid temperature 306, pump speed 308, motor speed 310, pump displacement 312, and motor displacement 314. As a further example, the determination of an operating state may be performed by a processing module 168 of a controller 160. The inputs may be received by a signal receiving module 164 and from one or more sensors in the hydrostatic drive system 104, such as a pump discharge pressure sensor 176, a pump fluid temperature sensor 178, etc. Further, an input may be indicative of a user input, such as from a TPS 154 or a lever position sensor 158.

At step 604, a system efficiency may be determined (e.g., calculated). The calculation of the system efficiency may be performed by the processing module 168 and may be based on a displacement ratio 318, a speed ratio 320, or a combination thereof. The system efficiency may reflect an overall system efficiency of the hydrostatic drive system 104, e.g., a relationship of the energy put into the system to the energy output from the system. As an example, the system efficiency may be calculated according to a relationship between the actual and the theoretical displacement and/or speed measurements. As another example, a displacement ratio may be calculated by forming a ratio of a pump displacement to the motor displacement or vice versa and a speed ratio may be calculated by forming a ratio of the pump speed to the motor speed or vice versa.

At step 606, a component wear estimate may be determined based on one or more of the system efficiency of the hydrostatic drive system 104, a displacement ratio 318, and a speed ratio 320. Yet another input may be a series of moving averages for the one or more system efficiencies.

At step 608, a remaining useful life (RUL) of the hydrostatic drive system 104 or component thereof may be determined. The remaining useful life may be determined based, in part, on the component wear estimate determined in step 606. For instance, the component wear estimate may be compared with a pre-specified wear threshold at which the hydrostatic drive 104 system is no longer useful—or may catastrophically fail—to arrive at the remaining useful life. The remaining useful life may be expressed as a time value of useful operation time (e.g., 10 hours of operation time). Based on the remaining useful life, a determination may be made that an alarm or RUL indicator should be communicated. For example, if the remaining useful life falls below a certain pre-set threshold, a determination may be made that an alarm or RUL indicator should be communicated. Further, it may be determined to update a display or indicator showing a repetitively updated remaining useful life.

At step 610, a response may be generated. The response may include communicating an alarm or RUL indicator to, for instance, the machine 100 operator. The alarm or RUL indicator may be communicated by sending an alarm signal to the user interface 190, which may include a digital display, a gauge, a light, an audio alarm, or any other device for communication with a user. For example, the alarm signal may cause a message or icon to appear on a digital display, an audio alarm to sound, or a warning light to light up. The alarm signal may also cause a display of a real-time remaining useful life, such as a gauge or indicator on a digital display, to update with the latest determined remaining useful life. By indicating such warnings to an operator or administrator, unscheduled downtime be minimized by reducing the likelihood of a pump or motor catastrophic failure and derivative hydraulic system component failures, for example.

Those of skill will appreciate that the various illustrative logical blocks, modules, and algorithm steps described in connection with the aspects disclosed herein may be implemented as electronic hardware, computer software, or combinations of both. To clearly illustrate this interchangeability of hardware and software, various illustrative components, blocks, modules, and steps have been described above generally in terms of their functionality.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., controller 160) that implements a portion or all of one or more of the technologies described herein may include a general-purpose computer system that includes or is configured to access one or more computer-accessible media.

FIG. 7 depicts a general-purpose computer system that includes or is configured to access one or more computer-accessible media. In the illustrated aspect, a computing device 700 may include one or more processors 710a, 710b, and/or 710n (which may be referred herein singularly as the processor 710 or in the plural as the processors 710) coupled to a system memory 720 via an input/output (I/O) interface 730. The computing device 700 may further include a network interface 740 coupled to an I/O interface 730.

In various aspects, the computing device 700 may be a uniprocessor system including one processor 710 or a multiprocessor system including several processors 710 (e.g., two, four, eight, or another suitable number). The processors 710 may be any suitable processors capable of executing instructions. For example, in various aspects, the processor(s) 710 may be general-purpose or embedded processors implementing any of a variety of instruction set architectures (ISAs), such as the x86, PowerPC, SPARC, or MIPS ISAs, or any other suitable ISA. In multiprocessor systems, each of the processors 710 may commonly, but not necessarily, implement the same ISA.

In some aspects, a graphics processing unit (“GPU”) 712 may participate in providing graphics rendering and/or physics processing capabilities. A GPU may, for example, include a highly parallelized processor architecture specialized for graphical computations. In some aspects, the processors 710 and the GPU 712 may be implemented as one or more of the same type of device.

The system memory 720 may be configured to store instructions and data accessible by the processor(s) 710. In various aspects, the system memory 720 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 720 as code 725 and data 726.

In one aspect, the I/O interface 730 may be configured to coordinate I/O traffic between the processor(s) 710, the system memory 720 and any peripherals in the device, including an network interface 740 or other peripheral interfaces. In some aspects, the I/O interface 730 may perform any necessary protocol, timing or other data transformations to convert data signals from one component (e.g., the system memory 720) into a format suitable for use by another component (e.g., the processor 710). In some aspects, the I/O interface 730 may include support for devices attached through various types of peripheral buses, such as a variant of the Peripheral Component Interconnect (PCI) bus standard or the Universal Serial Bus (USB) standard, for example. In some aspects, the function of the I/O interface 730 may be split into two or more separate components, such as a north bridge and a south bridge, for example. Also, in some aspects some or all of the functionality of the I/O interface 730, such as an interface to the system memory 720, may be incorporated directly into the processor 710.

The network interface 740 may be configured to allow data to be exchanged between the computing device 700 and other device or devices 760 attached to a network or networks 750, such as other computer systems or devices, for example. In various aspects, the network interface 740 may support communication via any suitable wired or wireless general data networks, such as types of Ethernet networks, for example. Additionally, the network interface 740 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 720 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 700 via the I/O interface 730. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 700 as the system memory 720 or another type of memory. Further, a computer-accessible medium may include transmission media or signals, such as electrical, electromagnetic or digital signals, conveyed via a communication medium, such as a network and/or a wireless link, such as those that may be implemented via the network interface 740. Portions or all of multiple computing devices, such as those illustrated in FIG. 7, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A method for analyzing wear of a component in a hydrostatic system comprising:
determining, by one or more processors, a first displacement ratio reflecting a relationship between a first displacement of a pump in a hydrostatic system and a first displacement of a motor fluidly coupled to the pump;
determining, by the one or more processors, a first speed ratio reflecting a relationship between a first speed of the pump and a first speed of the motor; and
determining a first system efficiency of the hydrostatic system based on the first displacement ratio and the first speed ratio, wherein the first system efficiency is indicative of wear of a component of the hydrostatic system.

2. The method of claim 1, where the first system efficiency comprises a weighted moving average of a system efficiency hydrostatic system.

3. The method of claim 1, further comprising:
determining a second displacement ratio reflecting a relationship between a second displacement of the pump and a second displacement of the motor;
determining a second speed ratio reflecting a relationship between a second speed of the pump and a second speed of the motor;
determining a second system efficiency based on the second displacement ratio and the second speed ratio; and
determining a third operational characteristic indicative of a wear estimation of a component of the hydrostatic system based at least on a comparison between the first system efficiency and the second system efficiency.

4. The method of claim 3, where the second system efficiency comprises a weighted moving average of a system efficiency hydrostatic system.

5. The method of claim 3, further comprising:
providing a response to a user interface, the response indicative of the wear estimation.

6. The method of claim 5, wherein the response comprises one or more of an audible and visual indicator.

7. A computer-implemented method comprising:
determining a first displacement ratio reflecting a relationship between a first displacement of a pump in a hydrostatic system and a first displacement of a motor fluidly coupled to the pump;
determining a first speed ratio reflecting a relationship between a first speed of the pump and a first speed of the motor; and
determining a first operational characteristic of the hydrostatic system based at least on the first displacement ratio and the first speed ratio, wherein the first operational characteristic is indicative of wear of a component of the hydrostatic system.

8. The method of claim 7, where the first operational characteristic comprises a weighted moving average of a system efficiency hydrostatic system.

9. The method of claim 1, further comprising:
determining a second displacement ratio reflecting a relationship between a second displacement of the pump and a second displacement of the motor;
determining a second speed ratio reflecting a relationship between a second speed of the pump and a second speed of the motor;
determining a second operational characteristic based on the second displacement ratio and the second speed ratio; and
determining a third operational characteristic based on a differential between the first operational characteristic and the second operational characteristic.

10. The method of claim 9, where the second operational characteristic comprises a weighted moving average of a system efficiency hydrostatic system.

11. The method of claim 9, wherein the first operational characteristic of the hydrostatic system is a first system efficiency characteristic and the second operational characteristic of the hydrostatic system is a second system efficiency characteristic.

12. The method of claim 9, wherein the third operational characteristic is indicative of a wear estimation of a component of the hydrostatic system.

13. The method of claim 9, further comprising:
providing a response to a user interface, the response indicative of the wear estimation.

14. The method of claim 13, wherein the response comprises one or more of an audible and visual indicator.

15. A system for analyzing wear of a component in a hydrostatic system comprising:
a processor; and
a memory bearing instructions that, upon execution by the processor, cause the system at least to:
determine a first displacement ratio reflecting a relationship between a first displacement of a pump in a hydrostatic system and a first displacement of a motor fluidly coupled to the pump;
determine a first speed ratio reflecting a relationship between a first speed of the pump and a first speed of the motor; and
determine a first system efficiency of the hydrostatic system based on the first displacement ratio and the first speed ratio, wherein the first system efficiency is indicative of wear of a component of the hydrostatic system.

16. The system of claim 15, where the first system efficiency comprises a weighted moving average of a system efficiency hydrostatic system.

17. The system of claim 15, the memory further comprising instructions that, upon execution by the processor, cause the system at least to:
determine a second displacement ratio reflecting a relationship between a second displacement of the pump and a second displacement of the motor;
determine a second speed ratio reflecting a relationship between a second speed of the pump and a second speed of the motor;
determine a second system efficiency based on the second displacement ratio and the second speed ratio; and
determine a third operational characteristic indicative of a wear estimation of a component of the hydrostatic system based at least on a comparison between the first system efficiency and the second system efficiency.

18. The system of claim 17, wherein the second system efficiency comprises a weighted moving average of a system efficiency hydrostatic system.

19. The system of claim 17, further comprising:
providing a response to a user interface, the response indicative of the wear estimation.

20. The system of claim 19, wherein the response comprises one or more of an audible and visual indicator.
